(19) United States
(12) Patent Application Publication
(10) Pub. No.: US 2026/0351175 A1
(43) Pub. Date: Nov. 5, 2026

(54) OVERDRIVE COMPENSATION FOR PANEL DISPLAY DEVICE

(71) Applicant: Synaptics Incorporated, San Jose, CA (US)

(72) Inventors: Takashi Nose, Kanagawa (JP); Hirobumi Furihata, Tokyo (JP); Akio Sugiyama, Tokyo (JP)

(21) Appl. No.: 19/638,436

(22) Filed: Apr. 3, 2026

Related U.S. Application Data
(60) Provisional application No. 63/791,762, filed on Apr. 21, 2025.

(51) Int. Cl. G09G 3/3233; G09G 3/20

(52) U.S. Cl. CPC G09G 3/3233; G09G 3/2007; G09G 2310/08; G09G 2340/16; G09G 2360/16

(57) ABSTRACT

In an exemplary embodiment, a display driver includes an overdrive compensation circuit and a data driver circuit. The overdrive compensation circuit is configured to store a pixel state map associated with a display panel; receive input pixel data for a pixel circuit of the display panel; retrieve pixel state data for the pixel circuit from the stored pixel state map; determine an overdrive (OD) value based on the input pixel data and the retrieved pixel state data; generate compensated pixel data for the pixel circuit based on the input pixel data and the OD value; and update the pixel state data for the pixel circuit in the stored pixel state map based on the input pixel data and the retrieved pixel state data. The data driver circuit is configured to drive the pixel circuit based on the compensated pixel data.

### CROSS-REFERENCE TO RELATED APPLICATIONS

This application claims the benefit of U.S. Provisional Application No. 63/791,762, titled “OVERDRIVE COMPENSATION FOR PANEL DISPLAY DEVICE” and filed on Apr. 21, 2025, which is incorporated by reference herein in its entirety.

### TECHNICAL FIELD

This disclosure relates generally to panel display devices and more particularly to overdrive compensation for panel display devices.

### BACKGROUND

Some display panels may be formed from an array of pixel circuits each configured to emit light in accordance with gray levels specified in pixel data. In one implementation, each row of pixel circuits may be coupled to a respective gate line and each column of pixel circuits may be coupled to a respective data (or source) line. Each pixel circuit may be updated by driving a relatively high voltage on a respective gate scan line to “select” or activate the respective row of pixel circuits, and driving a data voltage that corresponds to the specified gray level on a respective data line to apply the data voltage to that pixel circuit. Thus, a display panels may be updated by successively “scanning” the rows of pixel circuits (e.g., one row at a time) until each row of the array has been updated.

An issue with display updates is that due to large capacitances of pixel circuits and/or data lines, pixel circuits may require time to settle into the new states that allow the pixel circuits to emit light at the desired luminance. The settling time of a particular pixel circuit may depend on the degree of change in the state of that pixel circuit. For example, a transition from a maximum luminance state to a minimum luminance state may require more settling time than a transition from an intermediate luminance state to another intermediate luminance state. The delay in pixel circuit transition may cause motion blur and/or other visual artifacts to appear on the display image if the settling time of the pixels is slower than the time between successive image updates.

Overdrive compensation (ODC) is a technique for accelerating pixel transitions during display updates. In one implementation, a particular pixel circuit for which a large change in state is desired may be driven to an “overdriven” data voltage, which may be higher or lower than the data voltage originally corresponding to the specified gray level, and the “overdriven” data voltage charges the capacitances associated with the pixel circuit and the corresponding data line more quickly, allowing the pixel circuit to reach the desired luminance in less time.

### SUMMARY

This summary is provided to introduce, in a simplified form, a selection of concepts that will be further described below. This summary is not necessarily intended to identify key features or essential features of the present disclosure. The present disclosure may include the following various aspects and embodiments.

In an exemplary embodiment, a display driver includes an overdrive compensation circuit and a data driver circuit. The overdrive compensation circuit is configured to: store a pixel state map associated with a display panel; receive input pixel data for a pixel circuit of the display panel; retrieve pixel state data for the pixel circuit from the stored pixel state map; determine an overdrive (OD) value based on the input pixel data and the retrieved pixel state data; generate compensated pixel data for the pixel circuit based on the input pixel data and the OD value; and update the pixel state data for the pixel circuit in the pixel state map based on the input pixel data and the retrieved pixel state data. The data driver circuit is configured to drive the pixel circuit based on the compensated pixel data.

In another exemplary embodiment, a display device includes a display panel and a display panel. The display panel includes a pixel circuit which includes a current-driven light-emitting element. The display driver is configured to: store a pixel state map associated with a display panel; receive input pixel data for a pixel circuit of the display panel; retrieve pixel state data for the pixel circuit from the stored pixel state map; determine an overdrive (OD) value based on the input pixel data and the retrieved pixel state data; generate compensated pixel data for the pixel circuit based on the input pixel data and the OD value; update the pixel state data for the pixel circuit in the pixel state map based on the input pixel data and the retrieved pixel state data; and drive the pixel circuit based on the compensated pixel data.

In still another exemplary embodiment, a method for driving a display panel is provided. The method includes: storing a pixel state map associated with a display panel; receiving input pixel data for a pixel circuit of the display panel; retrieving pixel state data for the pixel circuit from the stored pixel state map; determining an overdrive (OD) value based on the input pixel data and the retrieved pixel state data; generating compensated pixel data for the pixel circuit based on the input pixel data and the OD value; updating the pixel state data for the pixel circuit in the pixel state map based on the input pixel data and the retrieved pixel state data; and driving the pixel circuit based on the compensated pixel data.

Other features and aspects are described in more detail below with reference to the attached drawings.

### BRIEF DESCRIPTION OF THE DRAWINGS

FIG. 1 shows an example of conventional overdrive compensation (ODC) for an organic light-emitting diode (OLED) display device.

FIG. 2 shows an example configuration of a display device, according to one or more embodiments.

FIG. 3 shows an example configuration of a display driver, according to one or more embodiments.

FIG. 4 shows an example configuration of an ODC circuit, according to one or more embodiments.

FIG. 5 shows an example of a low display brightness value (DVB) overdrive (OD) lookup table (LUT), according to one or more embodiments.

FIG. 6 shows an example of a low DBV update (UD) LUT, according to one or more embodiments.

FIG. 7 shows a timing diagram illustrating an example operation for determining OD values and update values for a particular pixel circuit, according to one or more embodiments.

FIG. 8 shows an example of a table lookup in a low DBV OD LUT, according to one or more embodiments.

FIG. 9 shows an example of a table lookup in a low DBV update LUT, according to one or more embodiments.

FIG. 10 shows an example of ODC for an OLED display device, according to one or more embodiments.

FIG. 11 shows an example configuration of an ODC circuit, according to other embodiments.

FIG. 12 shows an example process of driving a display panel, according to one or more embodiments.

For ease of understanding, where possible, identical reference numerals have been used to designate elements that are common to the figures. It is contemplated that elements disclosed in one embodiment may be utilized in other embodiments without specific recitation. Suffixes may be appended to reference numerals to distinguish elements from one another. The drawings referenced herein are not to be construed as being drawn to scale unless specifically noted. In addition, the drawings are often simplified and details or components are omitted for clarity of presentation and explanation. The drawings and discussion serve to explain principles discussed below.

### DETAILED DESCRIPTION

The following detailed description is exemplary in nature and is not intended to limit the disclosure or the applications and uses of the disclosure. Further, there is no intention to be bound by any expressed or implied theory presented in the preceding background, summary and brief description of the drawings, or in the following detailed description.

In the following detailed description, numerous specific details are set forth in order to provide a more thorough understanding of the disclosed technology. However, it will be apparent to one of ordinary skill in the art that the disclosed technology may be practiced without these specific details. In other instances, well-known features have not been described in detail to avoid unnecessarily complicating the description.

The term “coupled” as used herein means connected directly to or connected through one or more intervening components or circuits. Further, throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As discussed above, overdrive compensation (ODC) is a technique that facilitates the acceleration of pixel transitions during display updates. In one implementation, a particular pixel circuit in which a significant change in the state is desired between the previous frame and the current frame may be driven to an “overdriven” data voltage that may be higher or lower than the data voltage originally corresponding to the specified gray level for the current frame. The overdriven data voltage charges the capacitances associated with the pixel circuit and the corresponding data line more quickly, allowing the pixel circuit to reach the desired luminance in less time.

Since the change in state of each pixel circuit (or subpixel) corresponds to the change in gray level specified for that pixel circuit, overdrive compensation may be achieved by performing data processing on the gray level for each pixel circuit to determine a compensated gray level and generating the overdriven data voltage based on the compensated gray level to apply the overdriven data voltage to that pixel circuit. The data processing for achieving the overdrive compensation may be simply referred to as ODC processing in the following. Conventional ODC processing for a particular pixel circuit may include determining an overdrive value based on the difference in the gray level for that pixel circuit between the previous frame and the current frame, and determining the compensated gray level to be used to generate the overdriven data voltage for that pixel circuit by modifying the gray level specified for that pixel circuit for the current frame based on the overdrive value. In one implementation, the compensated gray level for a particular pixel circuit may be calculated as the sum of the original gray level for that pixel circuit and the overdrive value. Conventional ODC processing effectively enables a pixel circuit to emit light at the desired luminance during the frame period immediately following change in the gray level of the pixel circuit.

The present disclosure however recognizes that even when a pixel circuit is driven with an overdriven data voltage during the frame period immediately following a gray level change of that pixel circuit, the conventional ODC may cause an undesired luminance drop of that pixel circuit during one or more subsequent frame periods. The luminance drop during the one or more subsequent frame periods may hereinafter be referred to as multi-frame drop (MFD). The present disclosure recognizes that significant multi-frame drop may occur in implementations in which the pixel circuits of the display panel include current-driven light-emitting elements (e.g., light-emitting diodes (LEDs) such as organic light-emitting diodes (OLEDs)), particularly when the current-driven light-emitting elements are driven at reduced currents and/or for short periods of time.

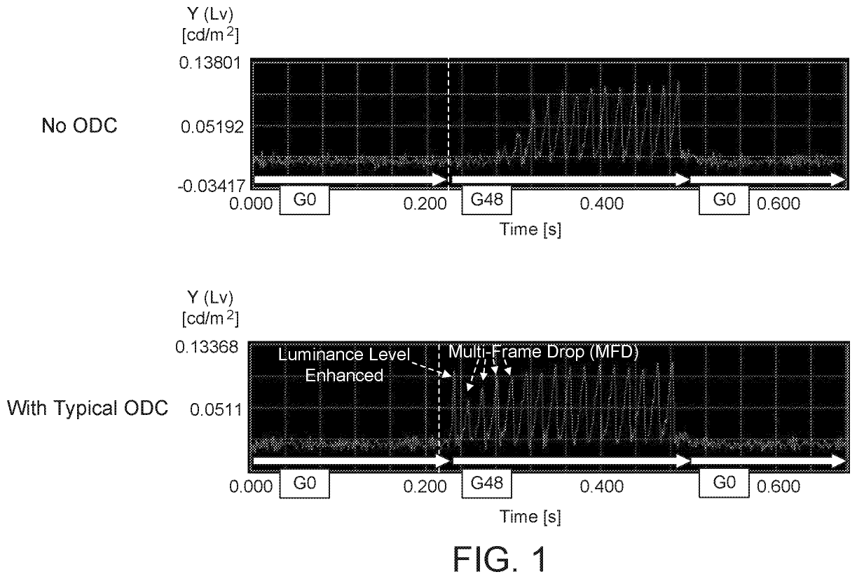

FIG. 1 shows an example of conventional ODC for an OLED display device in which pixel circuits each include an OLED element, which is a type of current-driven light-emitting element. FIG. 1 shows a measurement of the luminance level of a particular pixel circuit in the case where the gray level for that pixel circuit is changed from “0” to “48” while the OLED element in that pixel circuit is driven for a relatively short period of time. It should be noted that an OLED display device may be configured to adjust its display brightness level by controlling the duration for which the OLED elements in the respective pixel circuits are driven.

Referring to FIG. 1, while the luminance of the pixel circuit does not reach the desired luminance level without overdrive compensation (ODC) as shown in the upper diagram of FIG. 1, the conventional ODC, which drives the pixel circuit with an overdriven data voltage during the first frame period that occurs immediately after the change in the specified gray level, effectively mitigates the luminance drop of the pixel circuit during the first frame period as shown in the lower diagram of FIG. 1. However, the lower diagram of FIG. 1 also shows that the conventional ODC undesirably suffers from a significant MFD effect, i.e., the luminance drops during the subsequent frame periods.

The present disclosure recognizes that the MFD problem may result from the gate-to-drain capacitance, which is a type of parasitic capacitance, of the drive transistor that drives a drive current through the light-emitting element in each pixel element. When the drive current driven through the light-emitting element is small due to a reduced value of the specified gray level and/or when the period of time during which the drive current is driven through the light-emitting element is short due to a reduced value of the desired display brightness level, the drive current may not sufficiently charge the gate-to-drain capacitance of the drive transistor. This may cause unwanted charge transfer from the storage capacitor of the pixel element to the gate-to-drain capacitance of the drive transistor, which may result in a decrease in luminance during the subsequent frame periods. The present disclosure provides various techniques for mitigating the MFD problem in display devices that include an array of pixel circuits based on current-driven light-emitting elements.

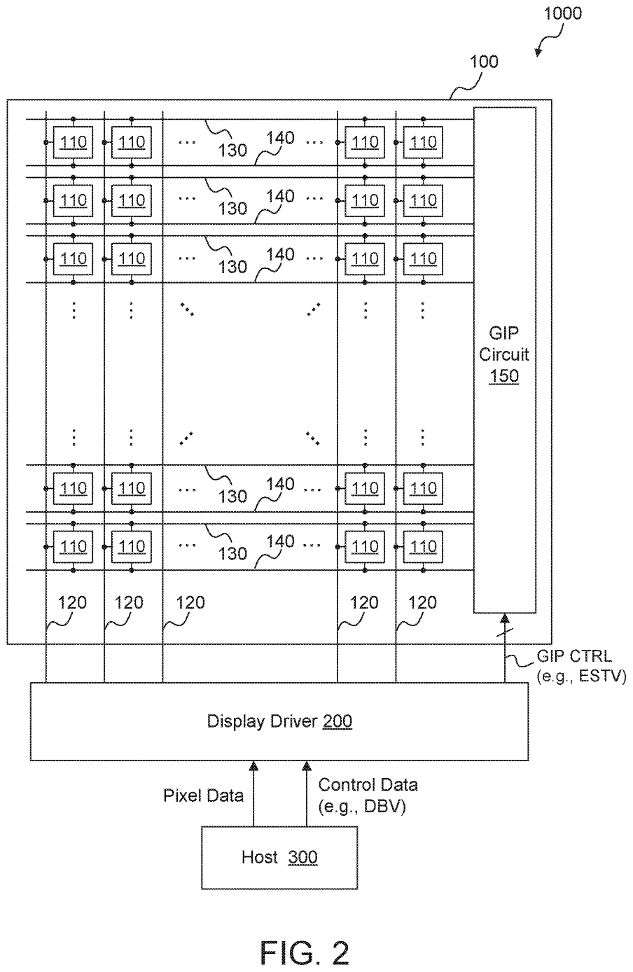

FIG. 2 shows an example configuration of a display device 1000, according to one or more embodiments. In the shown embodiment, the display device 1000 includes a display panel 100 and a display driver 200. The display panel 100 is a current-driven display panel that includes an array of pixel circuits 110, each of which includes a current-driven light-emitting element. In one implementation, each pixel circuit 110 may be configured to emit light of a desired color (e.g., red, green, and blue). In alternative embodiments, the current-driven light-emitting element of each pixel circuit 110 may be configured to emit white light such that the emitted white light passes through a color filter of the desired color. In implementations where the display panel 100 is an OLED display panel, each pixel circuit 110 includes an OLED element as the current-driven light-emitting element. The current-driven light-emitting element may be a different type of light-emitting diode. Each pixel circuit 110 may further include a storage capacitor configured to be programmed with a data voltage and a drive transistor configured to drive the current-driven light-emitting element with a drive current having a current level corresponding to the voltage across the storage capacitor. Each pixel circuit 110 operates as a subpixel, and a set of three or more pixel circuits 110 may form a pixel of the display panel 100. In one implementation, each pixel of the display panel 100 may include at least one pixel circuit 110 that functions as a red (R) subpixel that emits light of a red color, at least one pixel circuit 110 that functions as a green (G) subpixel that emits light of a green color, and at least one pixel circuit 110 that functions as a blue (B) subpixel that emits light of a blue color. Hereinafter, a pixel circuit 110 that functions as an R subpixel may be referred to as an R pixel circuit 110, a pixel circuit 110 that functions as a G subpixel may be referred to as a G pixel circuit 110, and a pixel circuit 110 that functions as a B subpixel may be referred to as a B pixel circuit 110.

In the shown embodiment, the display panel 100 includes a set of data lines 120, a set of gate scan lines 130, a set of emission scan lines 140, and a gate-in-panel (GIP) circuit 150. The data lines 120 are coupled to the display driver 200 and are used to provide data voltages generated by the display driver 200 to respective pixel circuits 110. The gate scan lines 130 are used to select a row of pixel circuits 110 to be updated or driven with the data voltages. In one implementation, when a row of pixel circuits 110 is to be updated, the gate scan line 130 coupled to the row of pixel circuits 110 is asserted (e.g., driven to a high voltage level) and the pixel circuits 110 of that row are programmed with the data voltages generated on the corresponding data lines 120. The emission scan lines 140 are used to control light emission from the respective rows of pixel circuits 110. In one implementation, the pixel circuits 110 of each row may be configured to emit light when the emission scan line 140 coupled to that row of pixel circuits 110 is asserted (e.g., driven to a high voltage level). The display brightness level of the display device 1000 may be adjusted by controlling the light emission duration from the respective pixel circuits 110 per frame period, which may be achieved by controlling the assertions of the emission scan lines 140. The GIP circuit 150 is configured to drive the gate scan lines 130 and the emission scan line 140 based on GIP control (CTRL) signals received from the display driver 200. In one implementation, the GIP control signals may include an emission scan start pulse signal ESTV, and the GIP circuit 150 may be configured to control the assertions of the emission scan lines 140 based on the emission scan start pulse signal ESTV to adjust the duration of light emission from the respective pixel circuits 110 per frame period.

The display driver 200 is configured to drive the display panel 100 to display an image on the display panel 100 based on pixel data received from a host 300. Examples of the host 300 include an application processor, a central processing unit (CPU), or other processors. The pixel data for each pixel of the display panel 100 may include gray levels for respective colors (i.e., respective pixel circuits 110 or subpixels) of that pixel. The display driver 200 is configured to generate data voltages based on the pixel data, and to provide the data voltages to the respective pixel circuits 110 via the data lines 120. The display driver 200 is further configured to receive control data from the host 300 which includes various control commands to control the overall operation of the display driver 200. In one implementation, the control data may include a brightness control command that indicates a display brightness value (DBV) that specifies the desired display brightness level of the display device 1000. The display brightness level referred to herein is the overall brightness level of the image displayed on the display panel 100. In one implementation, the host 300 is configured to control the display brightness level of the display device 1000 by providing the DBV to the display driver 200. The DBV may be generated based on a user operation. For example, when an instruction to adjust the display brightness level may be manually input to an input device, and the host 300 may generate the DBV based on this instruction to adjust the display brightness level. The input device may include a touch panel disposed on at least a portion of the display panel 100, a cursor control device, and mechanical and/or non-mechanical buttons. The display driver 200 may further be configured to generate the emission scan start pulse signal ESTV based on the DBV, and thereby control the display brightness level according to the DBV by adjusting the duration of light emission from the respective pixel circuits 110 per frame period.

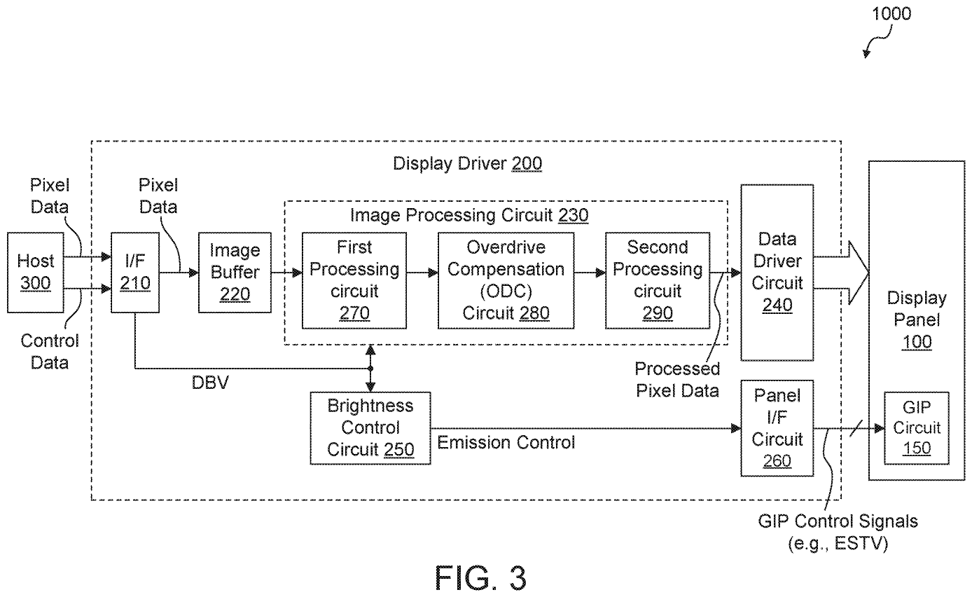

FIG. 3 shows an example configuration of the display driver 200, according to one or more embodiments. In the shown embodiment, the display driver 200 includes an interface (I/F) circuit 210, an image buffer 220, an image processing circuit 230, a data driver circuit 240, a brightness control circuit 250, and a panel interface (I/F) circuit 260. The interface circuit 210 is configured to receive pixel data from the host 300 and forward the pixel data to the image buffer 220. The interface circuit 210 is further configured to extract the DBV from the control data received from the host 300 and provide the DBV to the image processing circuit 230 and the brightness control circuit 250. The image buffer 220 is configured to temporarily store the pixel data, and provide the stored pixel data to the image processing circuit 230. The image processing circuit 230 is configured to process the pixel data received from the image buffer 220 to generate processed pixel data, and provide the processed pixel data to the data driver circuit 240. The data driver circuit 240 is configured to generate data voltages for the respective pixel circuits 110 based on the processed pixel data received from the image processing circuit 230.

In the shown embodiment, the image processing circuit 230 includes a first processing circuit 270, an overdrive compensation (ODC) circuit 280, and a second processing circuit 290. The first processing circuit 270 is configured to perform first image processing on the pixel data received from the image buffer 220. The first image processing performed by the first processing circuit 270 may include color adjustment, image scaling, demura correction, deburn correction, and other image processing. The ODC circuit 280 is configured to apply ODC processing to the resultant pixel data received from the first processing circuit 270 to generate compensated pixel data that includes compensated gray levels for the respective pixel circuits 110. As described in detail later, the ODC processing performed by the ODC circuit 280 is designed to mitigate the multi-frame drop (MFD) problem. In alternative embodiments, the first processing circuit 270 may be omitted, and the ODC circuit 280 may be configured to perform the ODC processing on the pixel data received from the image buffer 220. The second processing circuit 290 is configured to perform second image processing on the compensated pixel data received from the ODC circuit 280 to generate the processed pixel data to be provided to the data driver circuit 240. The second image processing performed by the second processing circuit 290 may include gamma transformation, color adjustment, image scaling, demura correction, deburn correction, and other image processing. In alternative embodiments, the second processing circuit 290 may be omitted and the ODC circuit 280 may be configured to provide the pixel data generated by the ODC processing as the processed pixel data to the data driver circuit 240.

The brightness control circuit 250 is configured to receive the DBV from the interface circuit 210 and generate an emission control parameter based on the DBV. The emission control parameter controls the light emission time duration of the pixel circuits 110 of the display panel 100. The brightness control circuit 250 is further configured to provide the emission control parameter to the panel interface circuit 260.

The panel interface circuit 260 is configured to generate and provide the GIP control signals to the GIP circuit 150 of the display panel 100. The panel interface circuit 260 may be configured to generate the GIP control signals based on the emission control parameter received from the brightness control circuit 250 such that the duration of light emission from the pixel circuits 110 per frame period increases as the DBV increases. In one implementation, the GIP control signals may include an emission scan start pulse signal ESTV, and the panel interface circuit 260 may be configured to generate the emission scan start pulse signal ESTV based on the DBV to control the duration of light emission from the pixel circuits 110 per frame period.

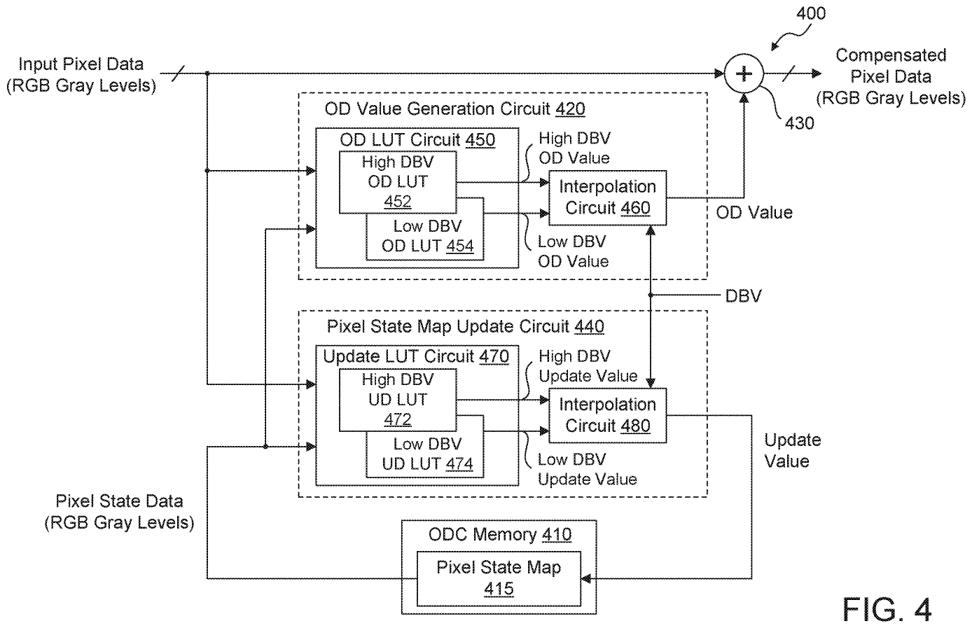

FIG. 4 shows an example configuration of an ODC circuit 400, according to one or more embodiments. The ODC circuit 400 may be one embodiment of the ODC circuit 280 shown in FIG. 3. The ODC circuit 400 is configured to apply ODC processing to input pixel data for each pixel of the display panel 100 to generate compensated pixel data. In the shown embodiment, the input pixel data for a particular pixel includes R, G, and B gray levels for the R, G, and B pixel circuits 110 of that pixel, and the compensated pixel data for that pixel includes compensated gray levels for the R, G, and B pixel circuits 110 of that pixel. The input pixel data may be the resultant pixel data generated by the first processing circuit 270 shown in FIG. 3, or the pixel data received from the image buffer 220 shown in FIG. 3. The compensated pixel data may be provided to the second processing circuit 290 shown in FIG. 3 or may be provided directly to the data driver circuit 240. In the embodiment shown in FIG. 4, the ODC circuit 400 includes an ODC memory 410, an overdrive (OD) value generation circuit 420, a compensation circuit 430, and a pixel state map update circuit 440.

The ODC memory 410 is configured to store a pixel state map 415 which represents estimated electrical states of the respective pixel circuits 110 (e.g., the R, G, and B pixel circuits 110) of each pixel for the entire display panel 100. In the shown embodiment, the pixel state map 415 represents the estimated electrical states of the respective pixel circuits 110 of each pixel in terms of gray levels. Specifically, when the pixel state map 415 indicates a gray level for a particular pixel circuit 110, it represents that that pixel circuit 110 is estimated to be in an electrical state that allows the pixel circuit 110 to emit light at the luminance level corresponding to that gray level. In the shown embodiment, the pixel state map 415 includes pixel state data for the respective pixels of the display panel 100, and the pixel state data for each pixel includes the gray levels that represent the electrical states of the respective pixel circuits 110 (e.g., the R, G, and B pixel circuits 110) of that pixel. As discussed in detail later, using the pixel state map 415 to generate the compensated pixel data effectively mitigates the multi-frame drop (MFD) effect. The ODC memory 410 is further configured to retrieve pixel state data for a pixel of interest (i.e., the pixel whose input pixel data is currently being subjected to the ODC processing) from the pixel state map 415 and provide the pixel state data to the OD value generation circuit 420 and the pixel state map update circuit 440.

The OD value generation circuit 420 is configured to generate and provide an OD value for each pixel circuit 110 to the compensation circuit 430. The OD value for a particular pixel circuit 110 is generated based on the gray level indicated by the input pixel data for that pixel circuit 110 and the gray level indicated by the pixel state data for that pixel circuit 110. In one implementation, the OD value generation circuit 420 may be further configured to receive the DBV and generate the OD value for each pixel circuit 110 further based on the DBV.

In the shown embodiment, the OD value generation circuit 420 includes an OD lookup table (LUT) circuit 450 and an interpolation circuit 460. The OD LUT circuit 450 includes a high DBV OD LUT 452 and a low DBV OD LUT 454. The high DBV OD LUT 452 is used to determine, for each pixel circuit 110, a high DBV OD value, which is an OD value corresponding to a particular high DBV (e.g., the maximum DBV), by performing a table lookup based on the gray level indicated by the input pixel data for that pixel circuit 110 and the gray level indicated by the pixel state data for that pixel circuit 110. The low DBV OD LUT 454 is used to determine, for each pixel circuit 110, a low DBV OD value, which is an OD value corresponding to a particular low DBV (e.g., the minimum DBV), by performing a table lookup based on the gray level indicated by the input pixel data for that pixel circuit 110 and the gray level indicated by the pixel state data for that pixel circuit 110. The interpolation circuit 460 is configured to determine the OD value for each pixel circuit 110 by interpolating between the high and low DBV OD values for that pixel circuit 110 based on the DBV. In some implementations, the OD value for a particular pixel circuit 110 may be determined according the following expression (1):

$$( OD value ) = \frac{{OD}_{H} \cdot ( DBV - {DBV}_{MIN} ) + {OD}_{L} \cdot ( {DBV}_{MAX} - DBV - {DBV}_{MIN} )}{{DBV}_{MAX} - {DBV}_{MIN}} , \qquad ( 1 )$$

where OD_{H} and OD_{L} are the high and low DBV OD values for that pixel circuit 110, respectively, DBV_{MAX} and DBV_{MIN} are the maximum and minimum DBVs, respectively. The interpolation circuit 460 is further configured to provide the OD value determined for each pixel circuit 110 to the compensation circuit 430.

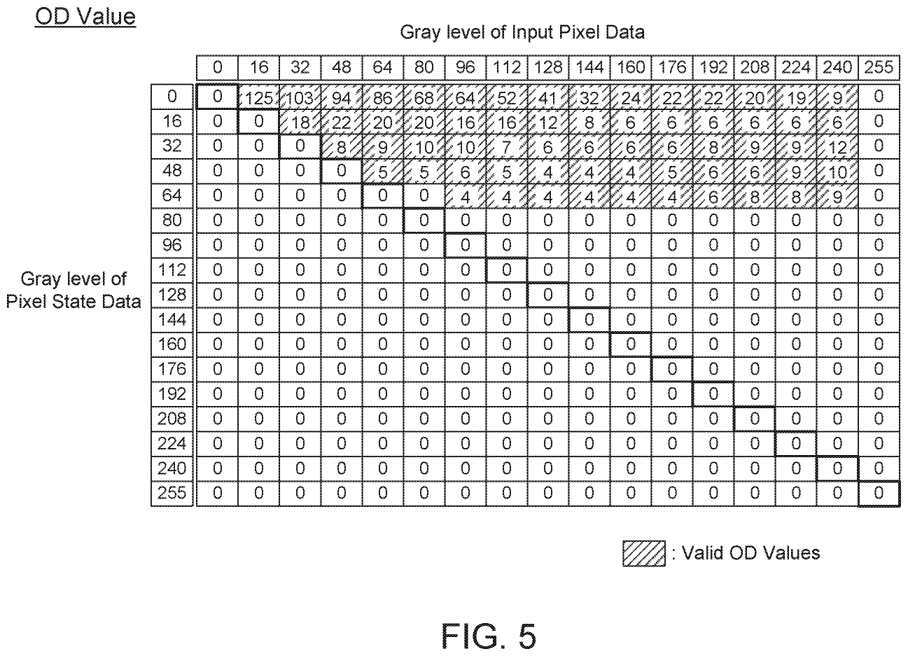

FIG. 5 shows an example of the contents of the low DBV OD LUT 454, according to one or more embodiments. The low DBV OD LUT 454 stores low DBV OD values corresponding to respective combinations of gray levels of the input pixel data and the pixel state data. The “0” value fields indicate the combinations of gray levels of the input pixel data and the pixel state data for which no overdrive compensation is performed. The OD value is set to “0” for the combinations of the same gray levels of the input pixel data and the pixel state data, since the overdrive compensation is not needed for these combinations. It should be noted that in order to reduce the size of the low DBV OD LUT 454, the low DBV OD LUT 454 does not necessarily describe the low DBV OD values for all possible gray levels of the input pixel data and all possible gray levels of the pixel state data. When the low DBV OD value for a particular combination of the gray level of the input pixel data and the gray level of the pixel state data is not described in the low DBV OD LUT 454, the low DBV OD value for that combination may be determined by interpolating between the low DBV OD values for nearby combinations of the gray level of the input pixel data and the gray level of the pixel state data during the table lookup process.

Similar to the low DBV OD LUT 454, the high DBV OD LUT 452 may store high DBV OD values corresponding to respective combinations of gray levels of the input pixel data and gray levels of the pixel state data. When the high DBV OD value for a particular combination of the gray level of the input pixel data and the gray level of the pixel state data is not described in the high DBV OD LUT 452, the high DBV OD value for that combination may be determined by interpolating between the high DBV OD values for nearby combinations of the gray level of the input pixel data and the gray level of the pixel state data during the table lookup process.

Referring back to FIG. 4, the compensation circuit 430 is configured to generate the compensated pixel data that indicates compensated gray levels for the respective pixel circuits 110 by modifying the input pixel data based on the OD values generated for the respective pixel circuits 110. In one implementation, the compensated gray level for a particular pixel circuit 110 may be determined by modifying the gray level of the input pixel data for that pixel circuit 110 based on the OD value generated for that pixel circuit 110. In one implementation, the compensated gray level for a particular pixel circuit 110 may be calculated as the sum of the gray level of the input pixel data for that pixel circuit 110 and the OD value generated for that pixel circuit 110.

The pixel state map update circuit 440 is configured to update the pixel state map 415 based on the input pixel data, the pixel state data received from the ODC memory 410, and the DBV. Specifically, the pixel state map update circuit 440 is configured to determine update values for the respective pixel circuits 110 of each pixel and update the gray levels of the pixel state data of that pixel of the pixel state map 415 to the update values. The pixel state map update circuit 440 is configured to determine the update value for a particular pixel circuit 110 so as to represent the electrical state of the pixel circuit 110 after the pixel circuit 110 is updated with the corresponding data voltage and then operated to emit light according to the data voltage. In one implementation, the update value for a particular pixel circuit 110 is determined based on the gray levels for that pixel circuit 110 indicated by the input pixel data and the pixel state data and the DBV.

In the shown embodiment, the pixel state map update circuit 440 includes an update LUT circuit 470 and an interpolation circuit 480. The update LUT circuit 470 includes a high DBV update LUT 472 and a low DBV update LUT 474. The high DBV update LUT 472 is used to determine, for each pixel circuit 110, a high DBV update value, which is an update value corresponding to a particular high DBV (e.g., the maximum DBV), by performing a table lookup based on the gray level indicated by the input pixel data for that pixel circuit 110 and the gray level indicated by the pixel state data for that pixel circuit 110. The low DBV update LUT 474 is used to determine, for each pixel circuit 110, a low DBV update value, which is an update value corresponding to a particular low DBV (e.g., the minimum DBV), by performing a table lookup based on the gray level indicated by the input pixel data for that pixel circuit 110 and the gray level indicated by the pixel state data for that pixel circuit 110. The interpolation circuit 480 is configured to determine the update value for each pixel circuit 110 by interpolating between the high and low DBV update values for that pixel circuit 110 based on the DBV. The interpolation circuit 480 is further configured to provide the update value determined for each pixel circuit 110 to the ODC memory 410, and to update the gray level for that pixel circuit 110 in the pixel state map 415 to the update value. In some implementations, the update value for a particular pixel circuit 110 may be determined according the following expression (2):

$$( Update value ) = \frac{{UD}_{H} \cdot ( DBV - {DBV}_{MIN} ) + {UD}_{L} \cdot ( {DBV}_{MAX} - DBV - {DBV}_{MIN} )}{{DBV}_{MAX} - {DBV}_{MIN}} , \qquad ( 2 )$$

where OD_{H} and OD_{L} are the high and low DBV OD values for that pixel circuit 110, respectively, and DBV_{MAX} and DBV_{MIN} are the maximum and minimum DBVs, respectively.

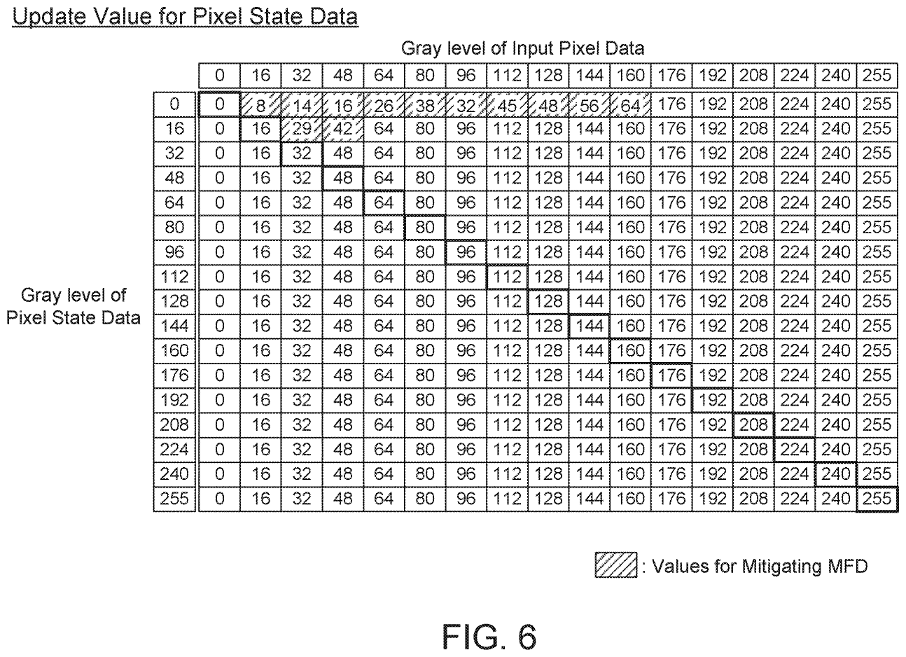

FIG. 6 shows an example of the contents of the low DBV update LUT 474, according to one or more embodiments. The low DBV update LUT 474 is configured to store low DBV update values corresponding to respective combinations of gray levels of the input pixel data and gray levels of the pixel state data. Some of the fields of the low DBV update LUT 474 indicate that the update value is different from the value of the gray level of the input pixel data (indicated by hatching), indicating that the estimated electrical state of the pixel circuit 110 should be represented by the update value rather than the gray level of the input pixel data. Other fields indicate that the update value is equal to the value of the gray level of the input pixel data, indicating that the estimated electrical state of the pixel circuit 110 can be represented by the gray level of the input pixel data because the MFD effect is not significant for the relevant combination of the gray levels of the input pixel data and the pixel state data. For the combinations of the same gray levels of the input pixel data and the pixel state data, the update value is equal to the value of the gray level of the input pixel data. It should be noted that in order to reduce the size of the low DBV update LUT 474, the low DBV update LUT 474 does not necessarily describe the low DBV update values for all possible gray levels of the input pixel data and all possible gray levels of the pixel state data. When the low DBV update value for a particular combination of the gray levels of the input pixel data and the pixel state data is not described in the low DBV update LUT 474, the low DBV update value for that combination may be determined by interpolating between the low DBV update values for nearby combinations of the gray levels of the input pixel data and the pixel state data during the table lookup process.

Similar to the low DBV update LUT 474, the high DBV update LUT 472 may be configured to store high DBV update values corresponding to respective combinations of gray levels of the input pixel data and gray levels of the pixel state data. When the high DBV update value for a particular combination of the gray level of the input pixel data and the gray level of the pixel state data is not described in the high DBV update LUT 472, the low DBV update value for that combination may be determined by interpolating between the high DBV update values for nearby combinations of the gray level of the input pixel data and the gray level of the pixel state data. In alternative embodiments, the high DBV update LUT 472 may be omitted and the gray levels for the respective pixel circuits 110 of the input pixel data may be used as the high DBV update values because the MFD effect is not significant at high DBVs. In such embodiments, the update value for each pixel circuit 110 may be determined by interpolating between the gray level specified by the input image data for that pixel circuit 110 and the low DBV update value for that pixel circuit 110 based on the DBV.

It is noted that the ODC circuit 400 shown in the embodiment of FIG. 4 uses the pixel state map 415 instead of a frame memory that stores pixel frame data for the previous frame. The present disclosure recognizes that even after a pixel circuit 110 is driven with an overdriven data voltage generated based on the compensated gray level during a frame period immediately following a change in the specified gray level, the pixel circuit 110 may not transition to the electrical state corresponding to the specified gray level, and this may cause a multi-frame drop (MFD) effect that lasts for one or more subsequent frame periods.

According to the inventors' study, a portion of the charge accumulated across the storage capacitor of the pixel circuit 110 may be transferred from the storage capacitor to the gate-to-drain capacitance of the drive transistor of the pixel circuit 110 after the drive transistor stops driving the drive current through the current-driven light-emitting element in the pixel circuit 110. This means that the pixel circuit 110 may transition to an electrical state different from that corresponding to the specified gray level. Because the charge transfer after driving the drive current may last for one or more frame periods subsequent to a change in the specified gray level, the charge transfer may be observed as a multi-frame drop (MFD) effect in the image displayed on the display panel 100. The amount of charge transferred from the storage capacitor to the gate-to-drain capacitance of the drive transistor increases as the drive current decreases and as the duration of light emission decreases. Therefore, the MFD effect may be enhanced when the specified gray level for the pixel circuit 110 is low and/or when the duration of light emission from the pixel circuit 110 is short. Since the pixel state map 415 represents the estimated electrical states of the respective pixel circuits 110 after the respective pixel circuits 110 are programmed with the corresponding data voltages, using the pixel state map 415 allows the ODC circuit 400 to generate the OD values more in accordance with the actual electrical states of the pixel circuits 110, thereby effectively mitigating the MFD effect.

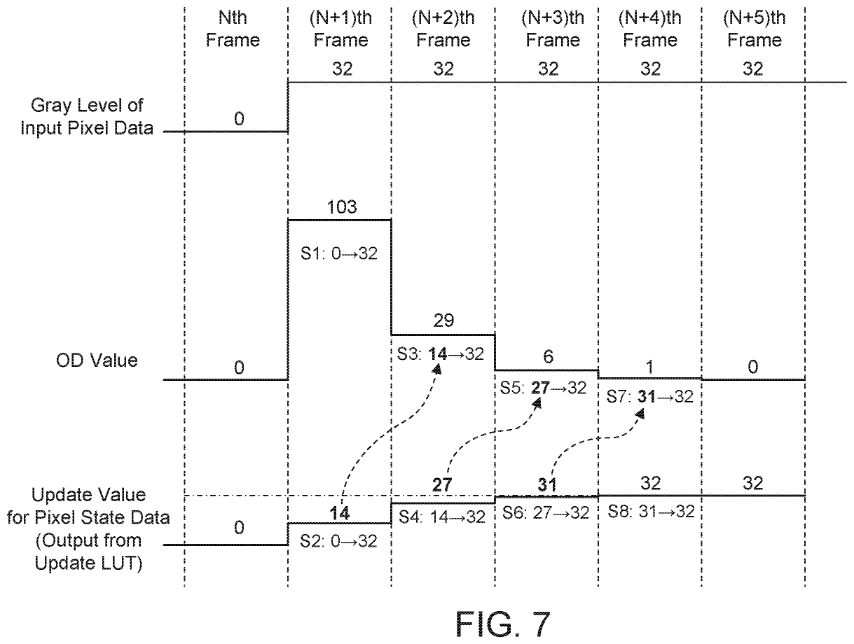

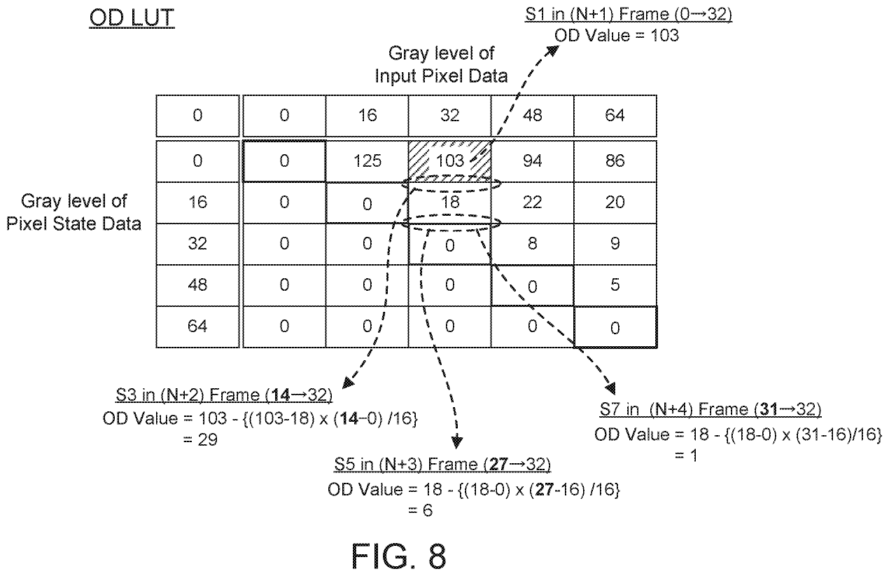

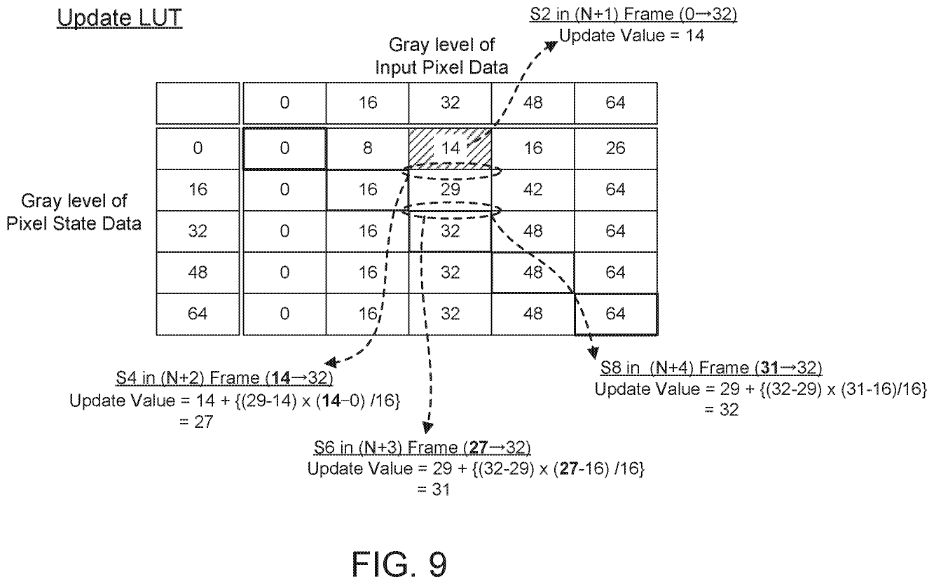

FIG. 7 shows a timing diagram illustrating an example operation for determining the overdrive (OD) values and the update values for a particular pixel circuit 110, hereinafter referred to as the target pixel circuit, for Nth to (N+5)th frame periods, according to one or more embodiments. The operation shown in FIG. 7 assumes that the gray level of the input pixel data for the target pixel circuit is maintained at “0” before the Nth frame period, and therefore the gray level of the pixel state data for the target pixel circuit in the pixel state map 415 is also “0”. For simplicity, the DBV is assumed to be the minimum DBV, which results in the OD values being determined using the low DBV OD LUT 454 without using the high DBV OD LUT 452, and the update values being determined using the low DBV update LUT 474 without using the high DBV update LUT 472. FIG. 8 shows an example of a table lookup in the low DBV OD LUT 454, while FIG. 9 shows an example of a table lookup in the low DBV update LUT 474. It should be noted that for DBVs other than “0”, the OD values may be determined by interpolation between the high DBV OD LUT 452 and the low DBV OD LUT 454, and the update values may be determined by interpolation between the high DBV update LUT 472 and the low DBV update LUT 474.

Referring back to FIG. 7, the gray level for the target pixel circuit 110 of the input pixel data is still maintained at “0” in the Nth frame period, and the OD value generation circuit 420 determines the OD value for the target pixel circuit to be “0”. Meanwhile, the pixel state map update circuit 440 determines the update value for the target pixel circuit, which indicates the estimated electrical state of the target pixel circuit in the (N+1)th frame period, to be “0”, and therefore the gray level of the pixel state data for the target pixel circuit in the pixel state map 415 is maintained at “0”.

In the (N+1)th frame period, the gray level for the target pixel circuit of the input pixel data is changed to “32”. Since the gray level of the pixel state data for the target pixel circuit 110 in the pixel state map 415 is “0”, the OD value generation circuit 420 determines the OD value for the target pixel circuit to be “103” (in step “S1”) by performing a table lookup in the low DBV OD LUT 454 as shown in FIG. 8. The ODC circuit 280 determines the compensated gray level for the target pixel circuit using the OD value of “103” to enhance the electrical state change of the target pixel circuit. Meanwhile, the pixel state map update circuit 440 determines the update value for the target pixel circuit to be “14” (in step “S2”) by performing a table lookup in the low DBV update LUT 474 as shown in FIG. 9. The pixel state map update circuit 440 updates the gray level of the pixel state data for the target pixel circuit in the pixel state map 415 to “14”.

In the (N+2)th frame period, the gray level for the target pixel circuit of the input pixel data is maintained at “32”. Although the gray level for the target pixel circuit of the input pixel data is not changed, the OD value generation circuit 420 determines the OD value for the target pixel circuit to be “29” (in step S3) by performing a table lookup in the low DBV OD LUT 454 (also see FIG. 8) based on the gray level for the target pixel circuit in the pixel state map 415 being “14”, which effectively mitigates the MFD effect during the (N+2)th frame period. It should be noted that the OD value for the target pixel circuit is determined by interpolation between the OD values for the “16” and “0” gray levels of the pixel state data. Meanwhile, the pixel state map update circuit 440 determines the update value for the target pixel circuit to be “27” (in step S4) by performing a table lookup in the low DBV update LUT 474 (see also FIG. 9). It should be noted that the update value for the target pixel circuit is determined by interpolation between the update values for the “16” and “0” gray levels of the pixel state data. The pixel state map update circuit 440 updates the gray level of the pixel state data for the target pixel circuit in the pixel state map 415 to “27”.

In the (N+3)th frame period, the gray level for the target pixel circuit of the input pixel data is still maintained at “32”. Although the gray level for the target pixel circuit of the input pixel data remains unchanged, the OD value generation circuit 420 determines the OD value for the target pixel circuit to be “6” (in step S5) by performing a table lookup in the low DBV OD LUT 454 (see also FIG. 8) based on the gray level for the target pixel circuit in the pixel state map 415 being “27”, which effectively mitigates the MFD effect during the (N+3)th frame period. It should be noted that the OD value for the target pixel circuit is determined by interpolation between the OD values for the “32” and “16” gray levels of the pixel state data. Meanwhile, the pixel state map update circuit 440 determines the update value for the target pixel circuit to be “31” (in step S4) by performing a table lookup in the low DBV update LUT 474 (see also FIG. 9). It should be noted that the update value for the target pixel circuit is determined by interpolation between the update values for the “32” and “16” gray levels of the pixel state data. The pixel state map update circuit 440 updates the gray level of the pixel state data for the target pixel circuit in the pixel state map 415 to “31”.

In the (N+4)th frame period, the gray level for the target pixel circuit of the input pixel data is still maintained at “32”. Although the gray level for the target pixel circuit of the input pixel data remains unchanged, the OD value generation circuit 420 determines the OD value for the target pixel circuit to be “1” (in step S7) by performing a table lookup in the low DBV OD LUT 454 (also see FIG. 8) based on the gray level for the target pixel circuit in the pixel state map 415 being “31”, which effectively mitigates the MFD effect during the (N+4)th frame period. It should be noted that the OD value for the target pixel circuit is determined by interpolation between the OD values for the “32” and “16” gray levels of the pixel state data. Meanwhile, the pixel state map update circuit 440 determines the update value for the target pixel circuit to be “32” (in step S8) by performing a table lookup in the low DBV update LUT 474 (also see FIG. 9). It should be noted that the update value for the target pixel circuit is determined by interpolation between the update values for the “32” and “16” gray levels of the pixel state data. The pixel state map update circuit 440 updates the gray level of the pixel state data for the target pixel circuit in the pixel state map 415 to “32”.

In the (N+5)th frame period, the gray level for the target pixel circuit of the input pixel data is still maintained at “32”. Since the gray level for the target pixel circuit in the pixel state map 415 is also “32”, the OD value generation circuit 420 determines the OD value for the target pixel circuit to be “0” by performing a table lookup in the low DBV OD LUT 454 (see also FIG. 8). Meanwhile, the pixel state map update circuit 440 determines the update value for the target pixel circuit to be “32”, and thus the gray level of the pixel state data for the target pixel circuit in the pixel state map 415 is maintained at “32”. As thus discussed, the process shown in FIG. 7, which uses the pixel state map 415 to generate the OD values, effectively mitigates the multi-frame drop (MFD) effect.

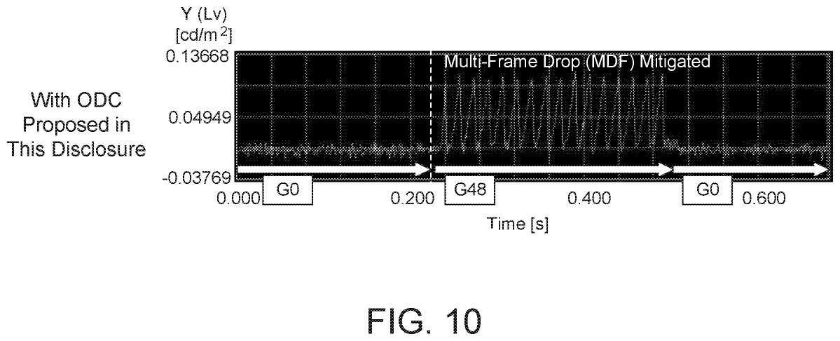

FIG. 10 shows an example of an ODC for an OLED display device, according to one or more embodiments. FIG. 10 shows a measurement of the luminance level of a particular pixel circuit as the gray level specified for that pixel circuit is changed from “0” to “48”. As can be understood from comparing the changes in luminance level between FIG. 1 and FIG. 10, the ODC of the present disclosure effectively increases the luminance level not only during the frame period immediately following the change in the specified gray level, but also during subsequent frame periods, thereby effectively mitigating the MFD effect.

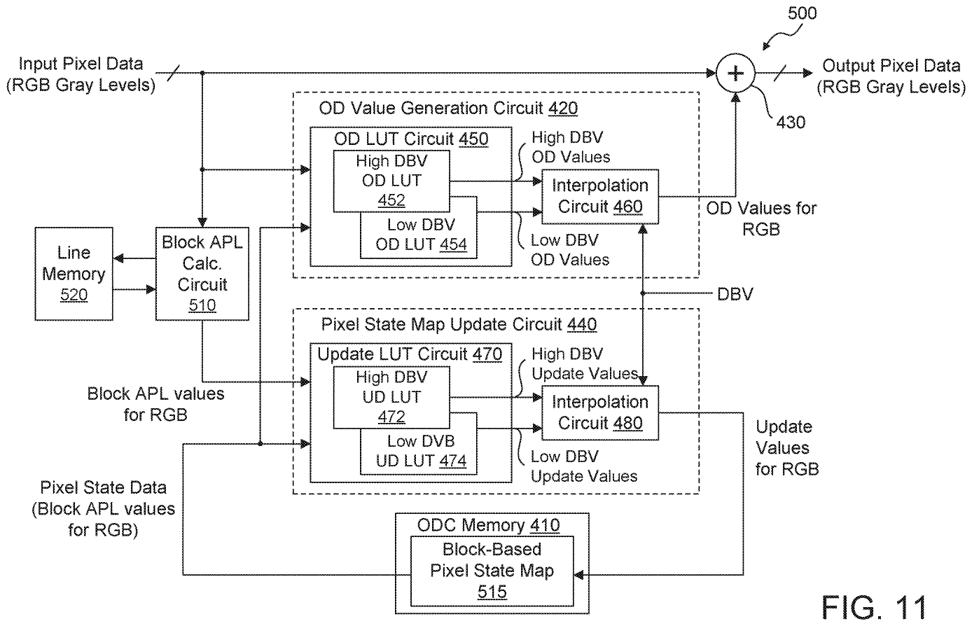

FIG. 11 shows another example configuration of an ODC circuit 500, according to other embodiments. The ODC circuit 500 may be another embodiment of the ODC circuit 280 shown in FIG. 3. As with the ODC circuit 400 shown in FIG. 4, the ODC circuit 500 is configured to perform ODC processing on input pixel data for each pixel of the display panel 100 to generate compensated pixel data, wherein the input pixel data for each pixel includes R, G, and B gray levels for R, G, and B pixel circuits 110 of that pixel and the compensated pixel data for that pixel includes compensated gray levels for the R, G, and B pixel circuits 110 of that pixel. The input pixel data may be the resultant pixel data generated by the first processing circuit 270 shown in FIG. 3 or the pixel data received from the image buffer 220 shown in FIG. 3, and the compensated pixel data may be provided to the second processing circuit 290 shown in FIG. 3 or provided directly to the data driver circuit 240.

The ODC circuit 500 is configured similarly to the ODC circuit 400 shown in FIG. 4, including the ODC memory 410, the OD value generation circuit 420, the compensation circuit 430, and the pixel state map update circuit 440; however, the ODC circuit 500 is configured to store a block-based pixel state map 515 in the ODC memory 410 instead of the pixel state map 415. As used herein, a “block” is a set of a predetermined number of pixels. The blocks may be defined such that each pixel of the display panel 100 belongs to one of the blocks. Each block may include pixels arranged in M rows and N columns, where M and N are natural numbers, at least one of which is greater than one.

The block-based pixel state map 515 includes pixel state data for respective blocks of the display panel 100. The pixel state data for a particular block of the block-based pixel state map 515 represents the estimated average electrical state of the pixel circuits of the pixels of that block in terms of gray levels. By using the block-based pixel state map 515 instead of the pixel state map 415, which has the pixel-based format, the required capacity of the ODC memory 410 may be reduced. In the shown embodiment, the pixel state data for a particular block includes an R block average picture level (APL) value, a G block APL value, and a B block APL value, wherein the R block APL value is indicative of the estimated average electrical state of the R pixel circuits 110 of the pixels of that block, the G block APL value is indicative of the estimated average electrical state of the G pixel circuits 110 of the pixels of that block, and the B block APL value is indicative of the estimated average electrical state of the B pixel circuits 110 of the pixels of that block.

The OD value generation circuit 420 is configured to determine the OD values for the respective pixel circuits 110 using the pixel state data retrieved from the block-based pixel state map 515, in addition to the input pixel data. The OD value generation circuit 420 is further configured to provide the OD values for the respective pixel circuits 110 to the compensation circuit 430, which is configured to generate compensated pixel data indicating compensated gray levels for the respective pixel circuits 110 by modifying the input pixel data based on the OD values generated for the respective pixel circuits 110.

In the embodiment shown in FIG. 11, the OD value generation circuit 420 is configured to determine the OD values for the R, G, and B pixel circuits 110 of the pixels of each block using the R, G, and B block APL values of the pixel state data for that block, respectively. In one implementation, the OD value generation circuit 420 may be configured to determine the OD value for an R pixel circuit 110 of a particular pixel of a particular block based on the gray level of the input pixel data for the R pixel circuit 110 and the R block APL value of the pixel state data for that block, determining the OD value for a G pixel circuit 110 of that pixel of that block based on the gray level of the input pixel data for the G pixel circuit 110 and the G block APL value of the pixel state data for that block, and determining the OD value for a B pixel circuit 110 of that pixel of that block based on the gray level of the input pixel data for the B pixel circuit 110 and the B block APL value of the pixel state data for that block. In one implementation, the OD LUT circuit 450 of the OD value generation circuit 420 may be configured to use as inputs the gray levels of the input pixel data and the R, G, and B block APL values of the pixel state data for the table lookup in the high DBV OD LUT 452 to determine the high DBV OD values for the R, G, and B pixel circuits 110 and for the table lookup in the low DBV OD LUT 454 to determine the low DBV OD values for the R, G, and B pixel circuits 110. The interpolation circuit 460 may be configured to determine the OD values for the respective pixel circuits 110 by interpolating between the high DBV OD values and the low DBV OD values for those pixel circuits 110 based on the DBV.

The ODC circuit 500 further includes a block APL calculation circuit 510 and a line memory 520. The block APL calculation circuit 510 is configured to calculate block APL values for respective blocks based on the input pixel data for the pixels of those blocks. The block APL calculation circuit 510 may be configured to calculate the block APL values for the respective blocks using the line memory 520 as a working memory. In one implementation, the block APL calculation circuit 510 may be configured to calculate an R block APL value of a particular block as the average of the gray levels of the input pixel data for the R pixel circuits 110 of the pixels of that block, a G block APL value of that block as the average of the gray levels of the input pixel data for the G pixel circuits 110 of the pixels of that block, and a B block APL value of that block as the average of the gray levels of the input pixel data for the B pixel circuits 110 of the pixels of that block.

In the embodiment shown in FIG. 11, the pixel state map update circuit 440 is configured to update the block-based pixel state map 515 based on the block APL values calculated from the input pixel data and the block APL values of the pixel state data retrieved from the block-based pixel state map 515. In one implementation, the pixel state map update circuit 440 may be configured to determine R, G, and B update values for respective blocks to represent the estimated average electrical states of the R, G, and B pixel circuits 110 of those blocks after the pixel circuits 110 are updated with the corresponding data voltages and then operated to emit light in accordance with the data voltages. The pixel state map update circuit 440 may further be configured to update the R, G, and B block APL values of the pixel state data of the block-based pixel state map 515 for a particular block with the R, G, and B update values of that block.

In one implementation, the update LUT circuit 470 of the pixel state map update circuit 440 may be configured to use as inputs the R, G, and B block APL values calculated from the input pixel data and the R, G, and B block APL values of the pixel state data to perform a table lookup in the high DBV update LUT 472 to determine the high DBV update values for the R, G, and B pixel circuits 110. The update LUT circuit 470 may also be configured to use as inputs the R, G, and B block APL values calculated from the input pixel data and the R, G, and B block APL values of the pixel state data to perform a table lookup in the low DBV update LUT 474 to determine the low DBV update values for the R, G, and B pixel circuits 110. The interpolation circuit 480 may be configured to determine the R, G, and B update values for the respective R, G, and B pixel circuits 110 by interpolating between the high DBV update values and the low DBV update values for R, G, and B pixel circuits 110 based on the DBV.

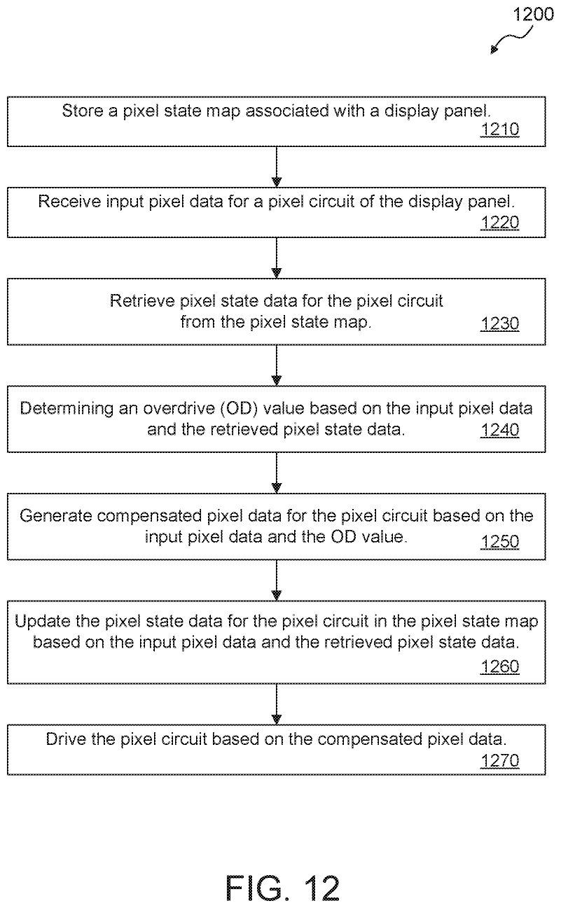

FIG. 12 shows an example process 1200 of driving a display panel, according to one or more embodiments. The process 1200 may be performed by any suitable display driver. Non-limiting examples include the display driver 200 shown in FIGS. 2 and 3. However, it will be appreciated that a display driver having additional and/or fewer components or a different configuration than those shown in FIGS. 2 and 3 may be used to perform the process 1200, that the following steps may be performed in any suitable order except where otherwise apparent by context, and that the process 1200 may be performed in any suitable environment.

The process 1200 includes storing a pixel state map (e.g., the pixel state map 415 shown in FIG. 4 and the block-based pixel state map 515 shown in FIG. 11) associated with a display panel (e.g., the display panel 100 shown in FIG. 2) in stage 1210. The process 1200 further includes receiving input pixel data for a pixel circuit (e.g., the pixels circuits 110 shown in FIG. 2) of the display panel in stage 1220. The process 1200 further includes retrieving pixel state data for the pixel circuit from the pixel state map in stage 1230. The process 1200 further includes determining an overdrive (OD) value based on the input pixel data and the retrieved pixel state data in stage 1240. The process 1200 further includes generating compensated pixel data for the pixel circuit based on the input pixel data and the OD value in stage 1250. The process 1200 further includes updating the pixel state data for the pixel circuit in the pixel state map based on the input pixel data and the retrieved pixel state data in stage 1260. The process 1200 further includes driving the pixel circuit based on the compensated pixel data in stage 1270.

In some embodiments, updating the pixel state data for the pixel circuit in the pixel state map may be further based on a display brightness value (DBV) specified for a display device that comprises the display panel. In some embodiments, the process 1200 may further include preparing a low DBV update lookup table (LUT) (e.g., the low DBV update LUT 474 shown in FIGS. 4 and 11) configured to store low DBV update values corresponding to respective combinations of gray levels of input pixel data and pixel state data for a first value of the DB and preparing a high DBV update LUT (e.g., the high DBV update LUT 472 shown in FIGS. 4 and 11) configured to store high DBV update values corresponding to respective combinations of gray levels of input pixel data and pixel state data for a second value of the DBV higher than the first value. In such embodiments, updating the pixel state data for the pixel circuit in the pixel state map may include: determining a low DBV update value from the low DBV update LUT based on the input pixel data and the retrieved pixel state data; determining a high DBV update value from the high DBV update LUT based on the input pixel data and the retrieved pixel state data; determining an update value for the pixel circuit by interpolating between the high DBV update value and the low DBV update value based on the DBV; and updating the pixel state data for the pixel circuit in the pixel state map based on the update value.

In some embodiments, the pixel state map may include a block-based pixel state map (e.g., the block-based pixel stage map 515 shown in FIG. 11) that includes pixel state data for respective blocks of the display panel, each of the blocks including a plurality of pixel circuits. In such embodiments, the pixel state data retrieved for the pixel circuit may include pixel state data retrieved for a block comprising the pixel circuit from the block-based pixel state map.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments are described herein. Variations of those exemplary embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A display driver, comprising:
an overdrive compensation circuit configured to:
store a pixel state map associated with a display panel;
receive input pixel data for a pixel circuit of the display panel;
retrieve pixel state data for the pixel circuit from the stored pixel state map;
determine an overdrive (OD) value based on the input pixel data and the retrieved pixel state data;
generate compensated pixel data for the pixel circuit based on the input pixel data and the OD value; and
update the pixel state data for the pixel circuit in the stored pixel state map based on the input pixel data and the retrieved pixel state data; and
a data driver circuit configured to drive the pixel circuit based on the compensated pixel data.

2. The display driver of claim 1, wherein updating the pixel state data for the pixel circuit in the stored pixel state map is further based on a display brightness value (DBV) specified for a display device that comprises the display panel.

3. The display driver of claim 2, wherein updating the pixel state data for the pixel circuit in the stored pixel state map comprises:
determining an update value based on the input pixel data, the retrieved pixel state data, and the DBV; and
updating the pixel state data for the pixel circuit in the stored pixel state map based on the update value.

4. The display driver of claim 3, wherein the overdrive compensation circuit comprises:
a low DBV update lookup table (LUT) configured to store low DBV update values corresponding to respective combinations of gray levels of input pixel data and pixel state data for a first value of the DBV; and
a high DBV update LUT configured to store high DBV update values corresponding to respective combinations of gray levels of input pixel data and pixel state data for a second value of the DBV higher than the first value, and
wherein determining the update value for the pixel circuit comprises:
determining a low DBV update value from the low DBV update LUT based on the input pixel data and the retrieved pixel state data;
determining a high DBV update value from the high DBV update LUT based on the input pixel data and the retrieved pixel state data; and
determining the update value for the pixel circuit by interpolating between the high DBV update value and the low DBV update value based on the DBV.

5. The display driver of claim 3, wherein the overdrive compensation circuit is configured to store a low DBV update lookup table (LUT) configured to store low DBV update values corresponding to respective combinations of gray levels of input pixel data and pixel state data for a first value of the DBV, and
wherein determining the update value for the pixel circuit comprises:
determining a low DBV update value by performing a lookup in the low DBV update LUT based on the input pixel data for the pixel circuit and the retrieved pixel state data for the pixel circuit; and
determining the update value for the pixel circuit by interpolating between a gray level specified by the input pixel data and the low DBV update value based on the DBV.

6. The display driver of claim 1, wherein the stored pixel state map comprises a block-based pixel state map comprising pixel state data for respective blocks of the display panel, each of the blocks including a plurality of pixel circuits, and
wherein the pixel state data retrieved for the pixel circuit comprises pixel state data retrieved for a block comprising the pixel circuit from the block-based pixel state map.

7. The display driver of claim 6, wherein updating the pixel state data for the pixel circuit in the stored pixel state map comprises:
calculating a block average picture level (APL) value for the block based on input pixel data for the block; and
updating the pixel state data for the block in the block-based pixel state map based on the block APL value for the block and the pixel state data retrieved for the block.

8. The display driver of claim 1, wherein determining the OD value for the pixel circuit is further based on a display brightness value (DBV) specified for a display device that comprises the display panel.

9. A display device, comprising:
a display panel comprising a pixel circuit which comprises a current-driven light-emitting element; and
a display driver configured to:
store a pixel state map associated with a display panel;
receive input pixel data for a pixel circuit of the display panel;
retrieve pixel state data for the pixel circuit from the stored pixel state map;
determine an overdrive (OD) value based on the input pixel data and the retrieved pixel state data;
generate compensated pixel data for the pixel circuit based on the input pixel data and the OD value;
update the pixel state data for the pixel circuit in the stored pixel state map based on the input pixel data and the retrieved pixel state data; and
drive the pixel circuit based on the compensated pixel data.

10. The display device of claim 9, wherein updating the pixel state data for the pixel circuit in the stored pixel state map is further based on a display brightness value (DBV) specified for a display device that comprises the display driver.

11. The display device of claim 10, wherein updating the pixel state data for the pixel circuit in the stored pixel state map comprises:
determining an update value based on the input pixel data, the retrieved pixel state data, and the DBV; and
updating the pixel state data for the pixel circuit in the stored pixel state map based on the update value.

12. The display device of claim 11, wherein the display driver comprises:
a low DBV update lookup table (LUT) configured to store low DBV update values corresponding to respective combinations of gray levels of input pixel data and pixel state data for a first value of the DBV; and
a high DBV update LUT configured to store high DBV update values corresponding to respective combinations of gray levels of input pixel data and pixel state data for a second value of the DBV higher than the first value, and
wherein determining the update value for the pixel circuit comprises:
determining a low DBV update value from the low DBV update LUT based on the input pixel data and the retrieved pixel state data;
determining a high DBV update value from the high DBV update LUT based on the input pixel data and the retrieved pixel state data; and
determining the update value for the pixel circuit by interpolating between the high DBV update value and the low DBV update value based on the DBV.

13. The display device of claim 11, wherein the display driver is further configured to store a low DBV update lookup table (LUT) configured to store low DBV update values corresponding to respective combinations of gray levels of input pixel data and pixel state data for a first value of the DBV, and
wherein determining the update value for the pixel circuit comprises:
determining a low DBV update value by performing a lookup in the low DBV update LUT based on the input pixel data for the pixel circuit and the retrieved pixel state data for the pixel circuit; and
determining the update value for the pixel circuit by interpolating between a gray level specified by the input pixel data and the low DBV update value based on the DBV.

14. The display device of claim 9, wherein the stored pixel state map comprises a block-based pixel state map comprising pixel state data for respective blocks of the display panel, each of the blocks including a plurality of pixel circuits, and
wherein the pixel state data retrieved for the pixel circuit comprises pixel state data retrieved for a block comprising the pixel circuit from the block-based pixel state map.

15. The display device of claim 14, wherein updating the pixel state data for the pixel circuit in the stored pixel state map comprises:
calculating a block average picture level (APL) value for the block based on input pixel data for the block; and
updating the pixel state data for the block in the block-based pixel state map based on the block APL value for the block and the pixel state data retrieved for the block.

16. The display driver of claim 9, wherein determining the OD value for the pixel circuit is further based on a display brightness value (DBV) specified for a display device that comprises the display driver.

17. A method, comprising:
storing a pixel state map associated with a display panel;
receiving input pixel data for a pixel circuit of the display panel;
retrieving pixel state data for the pixel circuit from the stored pixel state map;
determining an overdrive (OD) value based on the input pixel data and the retrieved pixel state data;
generating compensated pixel data for the pixel circuit based on the input pixel data and the OD value;
updating the pixel state data for the pixel circuit in the stored pixel state map based on the input pixel data and the retrieved pixel state data; and
driving the pixel circuit based on the compensated pixel data.

18. The method of claim 17, wherein updating the pixel state data for the pixel circuit in the stored pixel state map is further based on a display brightness value (DBV) specified for a display device that comprises the display panel.

19. The method of claim 18, wherein further comprising:
preparing a low DBV update lookup table (LUT) configured to store low DBV update values corresponding to respective combinations of gray levels of input pixel data and pixel state data for a first value of the DBV; and
preparing a high DBV update LUT configured to store high DBV update values corresponding to respective combinations of gray levels of input pixel data and pixel state data for a second value of the DBV higher than the first value, and
wherein updating the pixel state data for the pixel circuit in the stored pixel state map comprises:
determining a low DBV update value from the low DBV update LUT based on the input pixel data and the retrieved pixel state data;
determining a high DBV update value from the high DBV update LUT based on the input pixel data and the retrieved pixel state data;
determining an update value for the pixel circuit by interpolating between the high DBV update value and the low DBV update value based on the DBV; and
updating the pixel state data for the pixel circuit in the stored pixel state map based on the update value.

20. The method of claim 17, wherein the stored pixel state map comprises a block-based pixel state map comprising pixel state data for respective blocks of the display panel, each of the blocks including a plurality of pixel circuits, and
wherein the pixel state data retrieved for the pixel circuit comprises pixel state data retrieved for a block comprising the pixel circuit from the block-based pixel state map.
